(19) United States
(12) Patent Application Publication
(10) Pub. No.: US 2014/0152866 A1
(43) Pub. Date: Jun. 5, 2014

(54) RANKING COLOR CORRECTION PROCESSES

(71) Applicants: Ren Wu, San Jose, CA (US); Yu-Wei Wang, Fort Collins, CO (US)

(72) Inventors: Ren Wu, San Jose, CA (US); Yu-Wei Wang, Fort Collins, CO (US)

(21) Appl. No.: 14/131,491

(22) PCT Filed: Jul. 11, 2011
(86) PCT No.: PCT/US2011/043578

§ 371 Date: Jan. 8, 2014

(51) Int. Cl. H04N 1/60; H04N 5/262

(52) U.S. Cl. CPC H04N 1/6077; H04N 5/262; H04N 1/6086
USPC 348/223.1

(57) ABSTRACT

Systems and methods of ranking color correction processes are disclosed. An example method includes processing subimages of an image using a plurality of color correction processes. The method also includes ranking the plurality of results of color correction processes across the subimages. The method also includes applying color correction to the image based on the ranking of the color correction processes.

### BACKGROUND

Determining the color of light that illuminates a scene and correcting an image to account for the lighting effect, is referred to as the “color constancy problem,” and is a consideration for many imaging applications. For example, digital cameras may use a color constancy algorithm to detect the illuminant(s) for a scene, and make adjustments accordingly before generating a final image for the scene. The human eye is sensitive to imperfections. Therefore, performance of any color constancy algorithm has a direct effect on the perceived capability of the camera to produce quality images.

### BRIEF DESCRIPTION OF THE DRAWINGS

FIG. 1 shows an example imaging device which may be used for ranking color correction processes.

FIG. 2 is a high-level block diagram of example machine-readable modules which may be executed by an imaging device for ranking color correction processes.

FIGS. 3a-b are photographs illustrating example output based on ranking color correction processes.

FIGS. 4a-d are photographs illustrating example output based on ranking color correction processes.

FIG. 5 is a flowchart illustrating exemplary operations which may be implemented for ranking color correction processes.

### DETAILED DESCRIPTION

Imaging devices, such as digital cameras, may use illuminant detection process(es) to enhance color reproduction in the images. The performance of such processes contributes to the overall image quality of the imaging device. But because no single process has been shown to be significantly better than another process under all possible lighting conditions, more than one process may be implemented in an imaging device to determine the scene illuminant and make adjustments accordingly. Example processes include, but are not limited to, CbyC, BV Qualification, Gray World, Max RGB, and Gray Finding.

But implementing multiple processes presents another challenge. That is, how can the results from different processes be combined to give the desired output, particularly when different processes may give different results under the same lighting conditions. An ad-hoc or heuristic approach may be used, for example, relying on the experience of human “experts.” But these approaches are still error prone.

The systems and methods described herein disclose a new approach and framework where different processes are ranked during use or “on the fly.” An example uses the same image that is being analyzed, and each algorithm influences the outcome (e.g., the “voting power” of the algorithm is adjusted) based on the ranking of the algorithm. This approach is based on subimage analysis, and may be used with any of a wide variety of underlying processes on any of a wide variety of cameras or other imaging technologies, both now known and later developed. Another benefit is the ability of increasing statistical samples by using “sub-image” analysis. In other words, this approach is similar to capturing multiple images at the same scene (without having to actually capture a plurality of images), which increases the statistically meaningful sample size and arrive at a better decision based on the larger sample set.

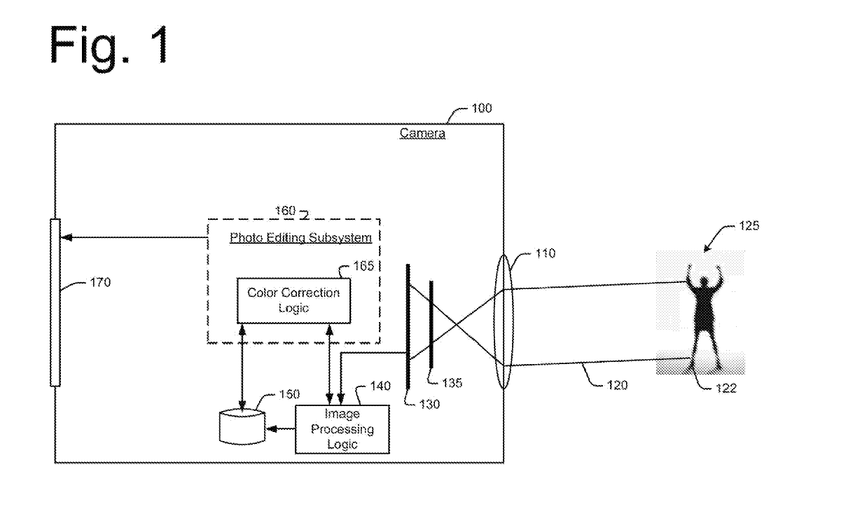

FIG. 1 shows an example imaging device which may be used for ranking color correction processes. The example imaging device or camera system may be a digital still camera or digital video camera (referred to generally herein as “camera”) 100. The camera 100 includes a lens 110 positioned to focus light 120 reflected from one or more objects 122 in a scene 125 onto an image capture device or image sensor 130 when a shutter 135 is open (e.g., for image exposure). Exemplary lens 110 may be any suitable lens which focuses light 120 reflected from the scene 125 onto image sensor 130.

Exemplary image sensor 130 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 130 may include, but is not limited to, a charge-coupled device (CCD), or a complementary metal oxide semiconductor (CMOS) sensor.

Camera 100 may also include image processing logic 140. In digital cameras, the image processing logic 140 receives electrical signals from the image sensor 130 representative of the light 120 captured by the image sensor 130 during exposure to generate a digital image of the scene 125. The digital image may be stored in the camera's memory 150 (e.g., a removable memory card).

Shutters, image sensors, memory, and image processing logic, such as those illustrated in FIG. 1, are well-understood in the camera and photography arts. These components may be readily provided for camera 100 by those having ordinary skill in the art after becoming familiar with the teachings herein, and therefore further description is not necessary.

Camera 100 may also include a photo-editing subsystem 160. In an exemplary embodiment, photo-editing subsystem 160 is implemented as machine readable instructions embodied in program code (e.g., firmware and/or software) residing in computer readable storage and executable by a processor in the camera 100. The photo-editing subsystem 160 may include color correction logic 165 for analyzing and correcting for color in the camera 100.

Color correction logic 165 may be operatively associated with the memory 150 for accessing a digital image (e.g., a pre-image) stored in the memory 150. For example, the color correction logic 165 may read images from memory 150, apply color correction to the images, and write the image with the applied color correction back to memory 150 for output to a user, for example, on a display 170 for the camera 100, for transfer to a computer or other device, and/or as a print.

Before continuing, it is noted that the camera 100 shown and described above with reference to FIG. 1 is an example of a camera which may implement the systems and methods described herein. However, ranking color correction processes is not limited to any particular camera or imaging device.

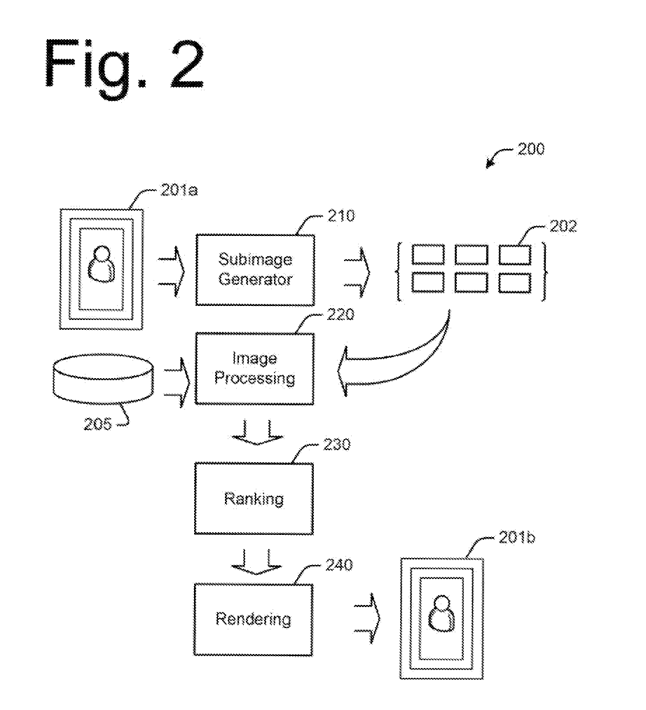

FIG. 2 is a high-level block diagram of example machine-readable modules 200 which may be executed by an imaging device for ranking color correction processes. In an example, the modules may be a part of the photo-editing subsystem 160 described above for FIG. 1. The modules may include a subimage generator 210 which generates subimages 202 from the same raw image data 201a. The modules may include an image processing module 220 to process subimages with a plurality of color correction processes stored in computer readable storage 205. The modules may include a ranking module 230 to rank color correction processes across the subimages 202. The modules may include a rendering module 240 to apply color correction to the raw image data 201a based on the ranking of the color correction processes, and generate an output image 201b.

For purposes of illustration, a set of images of the scene being photographed may be captured by “switching” a lens from wide angle to telephoto under constant conditions. Of course, multiple images are not necessarily taken using different lenses, because the scene conditions may change between image capture sessions. For example, the lighting, lens quality, and/or the camera angle may change if different lenses are used at different times to photograph the scene.

Instead, a single image is captured and stored in memory. Then, the subimage generator 210 crops portions from within the same image to obtain a set of subimages for the image. The set of images includes the same data, as though the image had been taken using a wide angle lens to capture the main image, and then the subimages had been taken of the same scene using a telephoto lens. Using subimage generator 210, the images and the subimages are based on the same conditions (both scene and camera conditions).

Next, the image processing module 220 may be implemented to process the set of images including the subimages for the image. For example, processing the set of images may include applying a color correction process to the set of images and obtaining results. This may be repeated using different color correction processes to obtain results for each of a plurality of color correction processes. The results from applying each of the color correction processes are then analyzed across the set of images, and the degree of influence each color correction process is allowed to have (e.g., the “vote” of each color correction process), is based on the results of the color correction processes for each of the applications of the color correction processes. Using a set of images results in more consistent results from each of the processes, which enables the system to better “understand the scene” being photographed.

In addition, image processing module 220 may use a plurality of color correction processes, now known and/or later developed. Example processes include, but are not limited to, CbyC, BV Qualification, Gray World, Max RGB, and Gray Finding. Image processing is not limited to use with any particular type of color correction processes. The performance of each color correction process is evaluated, for example, using statistical analysis.

In an example, some or all of the color correction processes are used to process the subimages, just as those processes would ordinarily process the overall image itself. The results of each process are analyzed to identify information, such as a mean and variance across the sub-image set. For purposes of illustration, this information is designated herein as F. The final result can then be determined using a function, designated herein as f(W, F), where W is a set of parameters. An example of this determination is shown for purposes of illustration by the following pseudocode:

```

[symbol]
R = ΣWᵢKᵢ/ΣWᵢ [symbol]
Wᵢ = (C − Vᵢ )*W^{v}ⱼ
  •••Vᵢ: normilized variance, (variance divided by Kᵢ)
  •••Vᵢ = Vᵢ/mean(Vᵢⱼ)
  •••Kᵢ: temperature from whole images by algorithm i
  •••Free parameters, C and W^{v}ᵢ [symbol]
Eᵢ = abs(Rᵢ − R′ⱼ)/R′ᵢ [symbol]
E = ΣEᵢ [symbol]
Minimize (E)
  •••Subject to C > 0, Wᵢ^{v} > 0
```

In the above pseudocode, R is the result and E is the error. It is also noted that “temperature” as used herein refers to color temperature. Color temperature is commonly defined such that lower Kelvin (K) ratings indicate “warmer” or more red and yellow colors in the light illuminating the scene. Higher Kelvin ratings indicate “cooler” or more blue color the light illuminating the scene.

While the value of W can be determined manually based on human experience, in another example the optimal values for W are determined automatically using machine learning and optimization technologies. Given a labeled dataset (e.g., output from processing each of the subimages using the color correction processes), machine learning and optimization technologies finds an optimum value of W so that the final result R has minimal errors E for the dataset. If the dataset is reasonable in size and content, the system yields better overall performance.

The ranking module 230 may then be used to rank color correction processes across the subimages. The amount or degree of influence each color correction process contributes to the final color correction process is based on the ranking. That is, the color correction process “votes” based on how well the color correction process performs for the particular scene being photographed.

It is noted that in some examples, a color correction process may have little or even no influence at all. In other examples, a single color correction process may have most or all of the voting power. But in many cases, a plurality of color correction processes will be used to various extends to apply color correction to the image being photographed.

Using multiple color correction processes enables better color correction in the final image. The rendering module 240 is then used to apply color correction to an image based on the ranking of the color correction processes.

A framework based on constraint programming was developed. In this example, 161 photos with RAW format were captured. The dataset was divided into two sets, images 1-100 and images 101-161. The first set was used for training, and the second set was used for measuring the errors.

TABLE 1

| Images | CCP1 | CCP2 | CCP3 | CCP4 | CCP5 | CCP6 | CCCP |
|---|---|---|---|---|---|---|---|
| 1-100 | 17.50% | 20.75% | 15.49% | 21.35% | 19/67% | 21.14% | 15.25% |
| 101-161 | 13.72% | 15.83% | 14.22% | 18.58% | 16.99% | 17.19% | 11.41% |
| All | 16.06% | 18.88% | 15.01% | 20.30% | 18.65% | 19.64% | 13.21% |

The error (E) in each entry of Table 1 is a mean absolute percentage error (MAPE). As can be seen in Table 1, each of the six known color correction processes (CCP1-CCP6) had higher error rates when used individually, when compared to the combined color correction process (CCCP) implementing the color correction ranking process described herein.

Accordingly, the color correction ranking process may be implemented as a system (e.g., in a digital camera) to rank any of a wide variety of different color correction processes during image capture or “on the fly,” based on the same image that is being captured and analyzed. Then each processes' voting power may be adjusted based on the corresponding ranking. No prior knowledge of the scene being photographed or the conditions is needed.

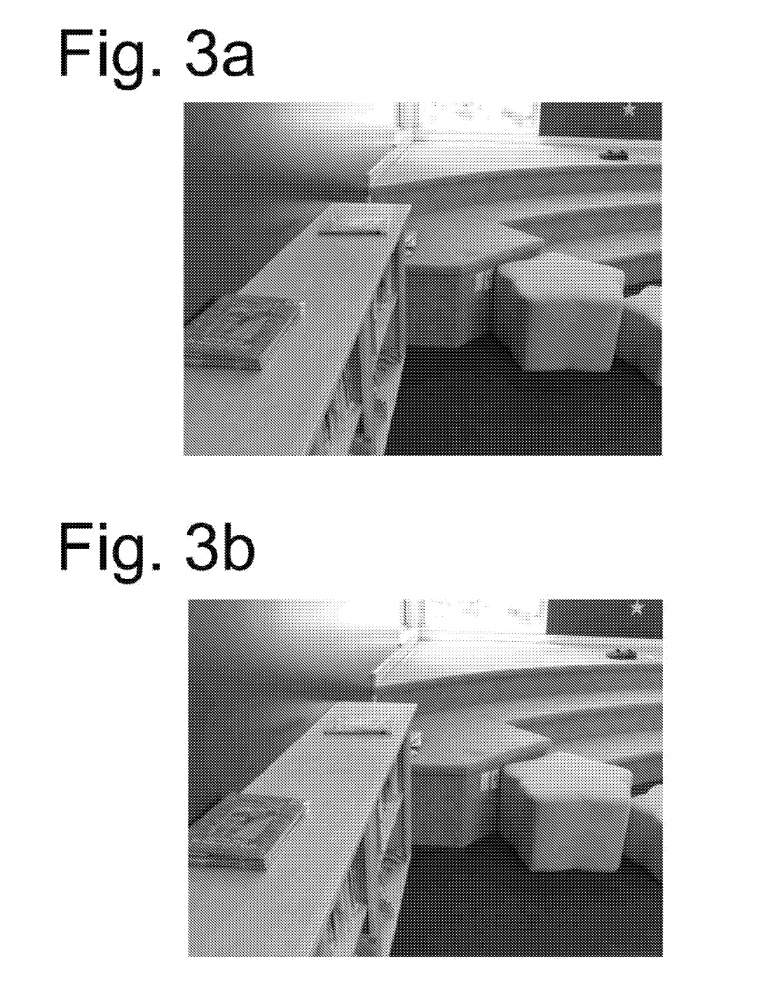

FIGS. 3a-b are photographs illustrating example output based on ranking color correction processes. In this example, a scene was photographed under mixed illumination. The mixed illuminants included inside lighting from lamps inside the room, and outside lighting from sunlight shining through the window.

It is noted that the systems and methods described herein may be implemented under any of a wide variety of lighting conditions. For example, different lighting conditions may exist inside a room even if there is no outside lighting. Such would be the case where both an incandescent light and a fluorescent light are used in or near the scene being photographed. In addition, different output from various light sources may also create a mixed illumination effect.

In this example, FIG. 3a shows the output from a digital camera which did not implement the ranking color correction processes described herein. The output includes a strong bluish tint and does not accurately reflect the “true” colors observed by someone standing in the room.

FIG. 3b shows the output from a digital camera which implemented the ranking color correction processes described herein. The difference between the cameras used to take the two photographs shown in FIGS. 3a-b was implementation of the ranking color correction processes. The photographs were otherwise taken from the same angle, at substantially the same time, under the same lighting conditions, and with all other factors remaining constant.

The output shown by the photograph in FIG. 3b much more accurately reflects the “true” colors observed by someone standing in the room Accordingly, it can be readily seen that the ranking color correction processes systems and methods described herein work well under mixed illuminant conditions, which are typically difficult to correct using other light detection and correction processes.

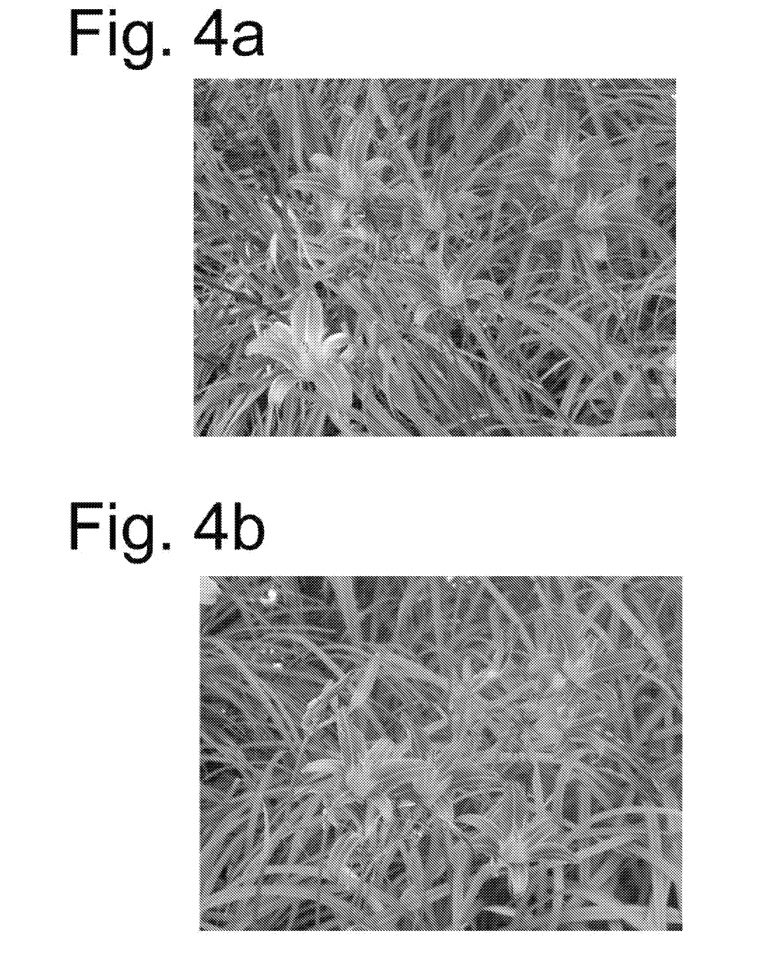

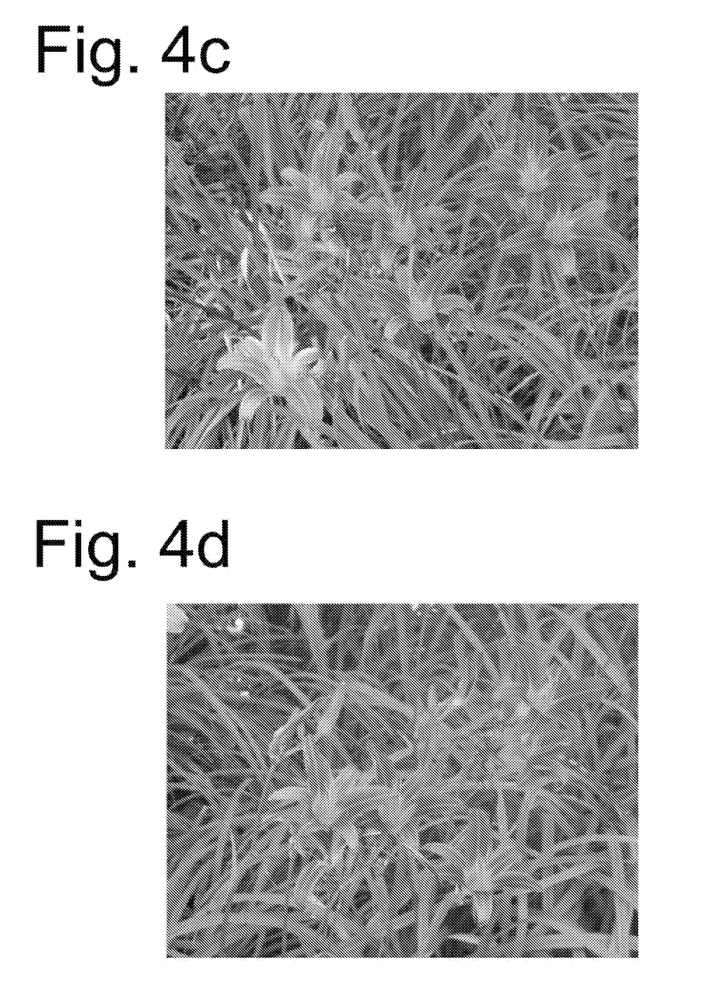

FIGS. 4a-d are photographs illustrating example output based on ranking color correction processes. In this example, a scene illuminated by a single source (e.g., outdoors in the sunlight) was photographed from different angles. Current illuminant detection processes can be sensitive to angle and/or other conditions. For example, the same camera can give quite different color results even when the camera view of the scene is only changed slightly.

It is noted that the systems and methods described herein may be implemented under any of a wide variety of conditions. For example, conditions that affect color determination and correction may include, but are not limited to, camera angle (also referred to as “angle of approach”), optical/digital zoom level, and lens characteristics.

In this example, the photographs shown in FIGS. 4a and 4c were taken using the same camera. The camera used to take the photographs shown in FIGS. 4a and 4c did not implement the ranking color correction processes described herein. Although taken under similar lighting conditions (and all conditions being the same other than the angle), the output shown in FIG. 4a has a bluish tint or cast when compared to the output shown in FIG. 4c.

The photographs shown in FIGS. 4b and 4d were taken using the same camera. The camera angle which produced the photograph in FIG. 4b was the same camera angle which produced the photograph in FIG. 4a. In other words, in FIGS. 4a-d there are two separate images captured by the same camera, but processed differently to show color consistency using the different methods.

The camera used to take the photographs shown in FIGS. 4b and 4d implemented the ranking color correction processes described herein. Even when taken under similar lighting conditions (and all conditions being the same other than the angle), the output shown in FIG. 4b and FIG. 4c is comparable. There is no bluish tint or cast when compared to the output shown in FIG. 4a. Accordingly, the ranking color correction processes produces more consistent results under a variety of different conditions.

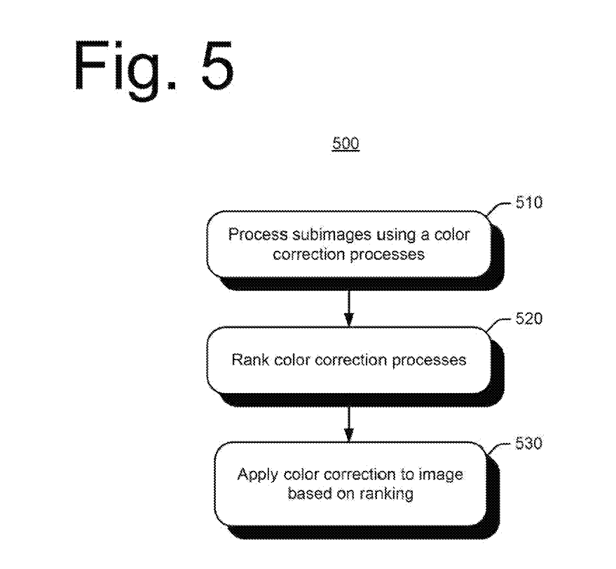

FIG. 5 is a flowchart illustrating exemplary operations which may be implemented for ranking color correction processes. Operations 500 may be embodied as logic instructions on one or more non-transient computer-readable medium. When executed on a processor, the logic instructions cause a general purpose computing device to be programmed as a special-purpose machine that implements the described operations. In an exemplary implementation, the components and connections depicted in the figures may be used.

In operation 510, subimages of an image are processed using a plurality of color correction processes; In an example, the subimages may include both wide angle crops and telephoto crops of the image. In another example, all of the subimages are crops from the same image.

In operation 520, color correction processes are ranked across the subimages. In operation 530, color correction is applied to the image based on the ranking of the color correction processes.

The operations shown and described herein are provided to illustrate example implementations of ranking color correction processes. It is noted that the operations are not limited to the ordering shown. Still other operations may also be implemented.

In an example, further operations may include ranking the color correction processes based on results from processing the subimages by the color correction processes. Further operations may also include ranking the color correction processes based on statistical analysis of results from processing the subimages by the color correction processes.

In another example, ranking the color correction processes is based on a function f(W, F) where F is the results from processing the subimages by each color correction process, and a W is set of parameters. Further operations may include optimizing W using machine learning. Further operations may also include determining W from a labeled dataset.

Still further operations may include ranking the color correction processes for use in color correction of the image using the image being analyzed for color correction. Further operations may also include adjusting voting power of each of the correction processes for use in color correction based on the ranking.

It is noted that the examples shown and described are provided for purposes of illustration and are not intended to be limiting. Still other examples are also contemplated.

1. A method of ranking color correction processes in imaging devices, comprising,
processing subimages of an image using a plurality of color correction processes;
ranking the plurality of results of color correction processes across the subimages; and
applying color correction to the image based on the ranking of the color correction processes.

2. The method of claim 1, wherein processing subimages includes applying color correction processes to the subimages to obtain color correction results.

3. The method of claim 1, wherein a degree of influence each color correction process contributes to applying color correction to the image is based on the ranking.

4. The method of claim 1, wherein ranking the color correction processes is based on statistical analysis of results from processing the subimages by the color correction processes.

5. The method of claim 1, wherein ranking the color correction processes is based on a function f(W, F) where F is results from processing the subimages by each color correction process, and W is a set of parameters.

6. The method of claim 5, further comprising determining W from a labeled dataset and optimizing W using machine learning.

7. A system for ranking color correction processes, comprising program code stored on non-transient computer readable media and executable on a processor in an imaging device to:
process subimages using a plurality of color correction processes;
rank color correction processes across the subimages; and
apply color correction to an image comprising the subimages based on the ranking of the color correction processes.

8. The system of claim 7, further comprising adjusting voting power of each color correction process based on a ranking, the ranking determining a degree of influence each color correction process contributes to a final color correction process.

9. The system of claim 7, wherein each color correction process is ranked for use in color correction using the same image being analyzed.

10. The system of claim 7, wherein the subimages include both wide angle crops and telephoto crops of the same image.

11. The system of claim 7, wherein a ranking of the color correction processes is based on results from processing the subimages by the color correction processes.

12. The system of claim 7, wherein a ranking of the color correction processes is based on statistical analysis of results from processing the subimages by the color correction processes.

13. The system of claim 7, wherein a ranking of the color correction processes is based on a function f(W, F) where F is the results from processing the subimages by each color correction process, and W is a set of parameters.

14. A camera system with ranking color correction processes, comprising:
an image processing module to process subimages with a plurality of color correction processes;
a ranking module to rank color correction processes across the subimages; and
a rendering module to apply color correction to an image based on the ranking of the color correction processes, the amount of influence each color correction process contributes to a final color correction process is based on the ranking.

15. The system of claim 14, wherein the subimages are wide angle crops and telephoto crops of the image.
